(19) United States
(12) Patent Application Publication
(10) Pub. No.: US 2013/0343358 A1
(43) Pub. Date: Dec. 26, 2013

(54) WIRELESS COMMUNICATION SYSTEM, BASE STATION APPARATUS, MOBILE STATION APPARATUS, WIRELESS COMMUNICATION METHOD, AND INTEGRATED CIRCUIT

(71) Applicants: Yasuyuki Kato, Osaka-shi (JP); Katsunari Uemura, Osaka-shi (JP)

(72) Inventors: Yasuyuki Kato, Osaka-shi (JP); Katsunari Uemura, Osaka-shi (JP)

(73) Assignee: SHARP KABUSHIKI KAISHA, Osaka-shi, Osaka (JP)

(21) Appl. No.: 14/004,181

(22) PCT Filed: Mar. 7, 2012
(86) PCT No.: PCT/JP2012/055759

§ 371 Date: Sep. 10, 2013

(30) Foreign Application Priority Data
Mar. 11, 2011 (JP) 2011-053736

(51) Int. Cl. H04W 72/04

(52) U.S. Cl. CPC H04W 72/0406
USPC 370/336

(57) ABSTRACT

A plurality of cells include one primary cell and one or more secondary cells. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. Upon receipt of a transmission timing message which contains transmission timing information and transmission timing group information regarding a transmission timing group to which the transmission timing information is to be applied, the mobile station apparatus applies the transmission timing information to a cell of a transmission timing group that is based on the transmission timing group information.

### TECHNICAL FIELD

The present invention relates to wireless communication systems, base station apparatuses, mobile station apparatuses, wireless communication methods, and integrated circuits and, more particularly, to an operation performed when notification of uplink transmission timing is made.

### BACKGROUND ART

W-CDMA has been standardized as a third generation cellular mobile communication scheme by 3GPP (3rd Generation Partnership Project), and services based thereon have been sequentially launched. Also, HSDPA with higher communication speed has been standardized, and services based thereon have been launched.

Also, in 3GPP, standardization of evolved third generation radio access (Evolved Universal Terrestrial Radio Access, hereinafter referred to as “EUTRA”) is progressing. As a downlink communication scheme of EUTRA, OFDM (Orthogonal Frequency Division Multiplexing) is employed which is robust against multipath interference and is suitable for high-speed transmission. As an uplink communication scheme of EUTRA, DFT (Discrete Fourier Transform)-spread OFDM, which is SC-FDMA (Single Carrier-Frequency Division Multiple Access) and which can reduce the PAPR (Peak to Average Power Ratio) of a transmit signal, is employed while taking cost and power consumption of mobile station apparatuses into consideration.

Moreover, in 3GPP, discussions over Advanced-EUTRA which is further advancements for EUTRA have begun. Advanced-EUTRA assumes communications at a downlink peak transmission rate of 1 Gbps or higher and at an uplink peak transmission rate of 500 Mbps or higher by using a band having a bandwidth of up to 100 MHz in each of the uplink and the downlink.

It is conceived that a band of up to 100 MHz is realized in Advanced-EUTRA by aggregating a plurality of EUTRA bands, each of which has a bandwidth of 20 MHz or less, in order to support EUTRA mobile station apparatuses. In Advanced-EUTRA, each EUTRA band of 20 MHz or less is called a component carrier (CC) (NPL 2). One downlink component carrier and one uplink component carrier constitute one cell. Note that one downlink component carrier alone can constitute one cell. The base station apparatus assigns a plurality of cells to each mobile station apparatus and performs communication with the mobile station apparatus via the assigned cells.

### CITATION LIST

### Non Patent Literature

NPL 1: 3GPP TS (Technical Specification) 36.300, V9.40 (2010-06), Evolved Universal Terrestrial Radio Access (E-UTRA) and Evolved Universal Terrestrial Radio Access Network (E-UTRAN), Overall description Stage 2
NPL 2: 3GPP TR (Technical Report) 36.814, V9.00 (2010-03), Evolved Universal Terrestrial Radio Access (E-UTRA) Further advancements for E-UTRA physical layer aspects

### SUMMARY OF INVENTION

### Technical Problem

In a case where a mobile station apparatus performs communication with a base station apparatus by using a plurality of cells, the mobile station apparatus sometimes accesses the base station apparatus via a repeater or the like. In such a case, the reception timing at which the mobile station apparatus receives data on the downlink component carrier differs from one cell to another. Furthermore, the transmission timing at which the mobile station apparatus performs transmission to the base station apparatus differs from one uplink component carrier of one cell to another uplink component carrier of another cell. For this reason, the mobile station apparatus is required to adjust the transmission timing for the uplink component carrier of each cell before transmitting data to the base station apparatus.

For this reason, notification of transmission timing information needs to be made for the uplink component carrier of each cell. However, in a case where there are a plurality of uplink component carriers having an identical transmission timing, making notification of transmission timing information for all the uplink component carriers indicates that the same transmission timing information is transmitted multiple times, resulting in a low radio resource utilization efficiency.

The present invention has been made in view of such circumstances, and aims to provide a wireless communication system, a base station apparatus, a mobile station apparatus, a wireless communication method, and an integrated circuit that enable efficient notification of transmission timing information and setting of the transmission timing information in a case where the transmission timing at which data is transmitted from the mobile station apparatus differs from one uplink component carrier to another.

### Solution to Problem

According to one embodiment, there is provided a wireless communication system in which a base station apparatus assigns a plurality of cells to a mobile station apparatus and in which the base station apparatus and the mobile station apparatus perform communication with each other via the plurality of cells. The plurality of cells include one primary cell which is always an activated cell and one or more secondary cells each of which is an activated cell or a deactivated cell. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. The base station apparatus transmits a transmission timing message to the mobile station apparatus via one cell among the plurality of cells, the transmission timing message containing transmission timing information and transmission timing group information regarding a transmission timing group to which the transmission timing information is to be applied. The mobile station apparatus applies, in a case where the mobile station apparatus has received the transmission timing message, the transmission timing information to a cell of a transmission timing group that is based on the transmission timing group information.

Preferably, a cell of a transmission timing group that is based on the transmission timing group information is an activated cell.

According to one embodiment, there is provided a base station apparatus that assigns a plurality of cells to a mobile station apparatus and that performs communication with the mobile station apparatus via the plurality of cells. The plurality of cells include one primary cell which is always an activated cell and one or more secondary cells each of which is an activated cell or a deactivated cell. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. The base station apparatus is configured to transmit a transmission timing message to the mobile station apparatus via one cell among the plurality of cells, the transmission timing message containing transmission timing information and transmission timing group information regarding a transmission timing group to which the transmission timing information is to be applied.

According to one embodiment, there is provided a mobile station apparatus that is assigned a plurality of cells by a base station apparatus and that performs communication with the base station apparatus via the plurality of cells. The plurality of cells include one primary cell which is always an activated cell and one or more secondary cells each of which is an activated cell or a deactivated cell. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. The mobile station apparatus is configured to apply, in a case where the mobile station apparatus has received a transmission timing message from the base station apparatus via one cell, the transmission timing message containing transmission timing information and transmission timing group information regarding a transmission timing group to which the transmission timing information is to be applied, the transmission timing information to a cell of a transmission timing group that is based on the transmission timing group information.

Preferably, the transmission timing information is applied to an activated cell of the transmission timing group.

According to one embodiment, there is provided a wireless communication method employed in a wireless communication system in which a base station apparatus assigns a plurality of cells to a mobile station apparatus and in which the base station apparatus and the mobile station apparatus perform communication with each other via the plurality of cells. The plurality of cells include one primary cell which is always an activated cell and one or more secondary cells each of which is an activated cell or a deactivated cell. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. The wireless communication method includes a step of transmitting, by the base station apparatus, a transmission timing message to the mobile station apparatus via one cell among the plurality of cells, the transmission timing message containing transmission timing information and transmission timing group information regarding a transmission timing group to which the transmission timing information is to be applied; a step of receiving, by the mobile station apparatus, the transmission timing message; and a step of applying, by the mobile station apparatus, the transmission timing information to an activated cell of the transmission timing group that is based on the transmission timing group information.

According to one embodiment, there is provided an integrated circuit employed in a base station apparatus that assigns a plurality of cells to a mobile station apparatus and that performs communication with the mobile station apparatus via the plurality of cells. The plurality of cells include one primary cell which is always an activated cell and one or more secondary cells each of which is an activated cell or a deactivated cell. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. The integrated circuit includes means for transmitting a transmission timing message to the mobile station apparatus via one cell among the plurality of cells, the transmission timing message containing transmission timing information and transmission timing group information regarding a transmission timing group to which the transmission timing information is to be applied.

According to one embodiment, there is provided an integrated circuit employed in a mobile station apparatus that is assigned a plurality of cells by a base station apparatus and that performs communication with the base station, apparatus via the plurality of cells. The plurality of cells include one primary cell which is always an activated cell and one or more secondary cells each of which is an activated cell or a deactivated cell. The primary cell and the secondary cells are grouped into a first transmission timing group that includes a secondary cell having an uplink transmission timing that is the same as an uplink transmission timing of the primary cell, and a second transmission timing group that includes secondary cells having an identical uplink transmission timing that is different from the uplink transmission timing of the primary cell. The integrated circuit includes means for receiving a transmission timing message from the base station apparatus via one cell among the plurality of cells, the transmission timing message containing transmission timing information and transmission timing group information regarding a transmission timing group to which the transmission timing information is to be applied; and means for applying the transmission timing information to an activated cell of the transmission timing group that is based on the transmission timing group information.

### Advantageous Effects of Invention

According to the present invention, in a case where the uplink transmission timing differs from one cell to another, notification of just one piece of transmission timing information is required for one transmission timing group, and thus radio resources are not used unnecessarily to make notification of the transmission timing information.

### BRIEF DESCRIPTION OF DRAWINGS

FIG. 1 is a diagram illustrating the channel configuration in EUTRA.

FIG. 2 is a diagram illustrating the configuration of uplink in EUTRA.

FIG. 3 is a diagram illustrating a contention based random access procedure.

FIG. 4 is a diagram illustrating a non-contention based random access procedure.

FIG. 5 is a diagram illustrating a transmission timing updating procedure.

FIG. 6 is an explanatory diagram regarding downlink component carriers in Advanced-EUTRA.

FIG. 7 is an explanatory diagram regarding uplink component carriers in Advanced-EUTRA.

FIG. 8 is a diagram illustrating an example in which a mobile station apparatus communicates with a base station apparatus via repeaters.

FIG. 9 is a diagram illustrating the configuration of a mobile station apparatus according to an embodiment of the present invention.

FIG. 10 is a diagram illustrating the configuration of a base station apparatus according to the embodiment of the present invention.

FIG. 11 is a diagram illustrating an example of the configuration of cells according to the embodiment of the present invention.

FIG. 12 is a flowchart illustrating an example of an operation of the mobile station apparatus in response to reception of a transmission timing message.

### DESCRIPTION OF EMBODIMENTS

Downlink of EUTRA is constituted by a downlink reference signal, a downlink synchronization channel DSCH, a physical downlink shared channel PDSCH, a physical downlink control channel PDCCH, and a physical broadcast channel PBCH.

Uplink of EUTRA is constituted by an uplink reference signal, a random access channel RACH, a physical uplink shared channel PUSCH, and a physical uplink control channel PUCCH. Also, there are two kinds of uplink reference signal: a demodulation reference signal and a sounding reference signal.

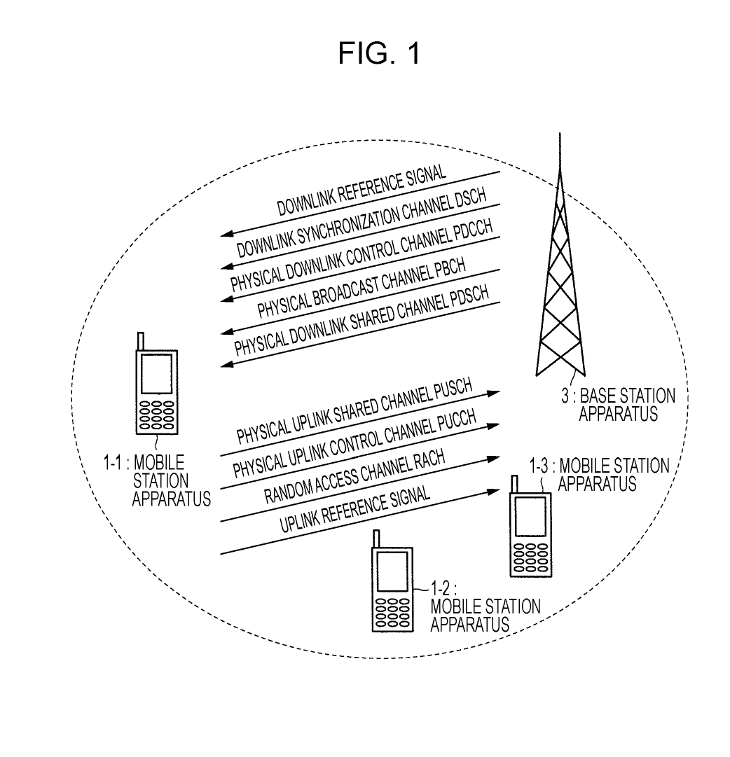

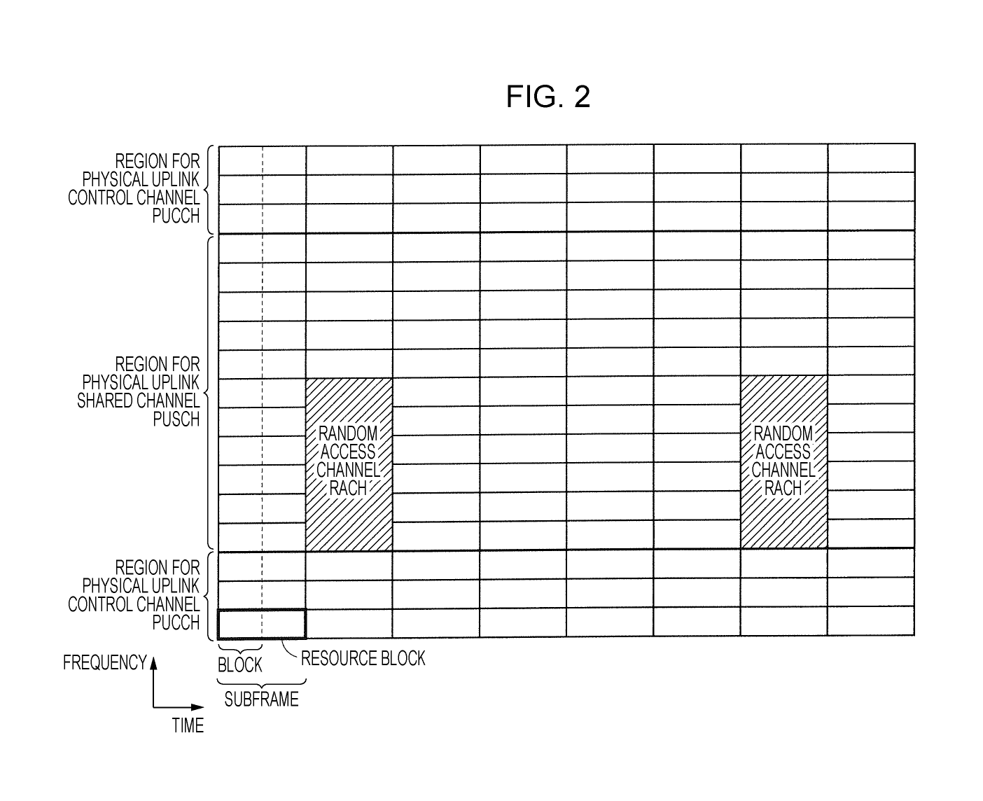

FIG. 1 is a diagram illustrating the channel configuration in EUTRA. FIG. 2 is a diagram illustrating the configuration of uplink in EUTRA. One block is constituted by twelve subcarriers and by seven OFDM symbols. Two blocks constitute one resource block (RB). One resource block is used for each of the physical uplink shared channel PUSCH and the physical uplink control channel PUCCH. Six resource blocks are used to form the random access channel RACH.

The uplink reference signal is mapped to specific OFDM symbols within each resource block. As illustrated in FIG. 2, the individual uplink channels are distributed to a region for the physical uplink shared channel PUSCH, a region for the physical uplink control channel PUCCH, and the random access channel RACH. Information about the region for the physical uplink shared channel PUSCH and the region for the physical uplink control channel PUCCH is broadcast from the base station apparatus. The base station apparatus also allocates, to each mobile station apparatus, radio resources for the physical uplink shared channel PUSCH and the physical uplink control channel PUCCH from the corresponding regions. Note that the random access channel RACH is mapped at certain intervals.

The physical downlink shared channel PDSCH is used for transmitting user data and control data from the base station apparatus to the mobile station apparatus. The physical downlink control channel PDCCH is used by the base station apparatus to notify the mobile station apparatus of control information, such as radio resource allocation information for the physical downlink shared channel PDSCH and the physical uplink shared channel PUSCH. The downlink reference signal is used for demodulating the physical downlink shared channel PDSCH and the physical downlink control channel PDCCH. The downlink synchronization channel DSCH is used by the mobile station apparatus to establish downlink synchronization. The physical broadcast channel PBCH is used to broadcast information regarding the system of the base station apparatus.

The physical uplink shared channel PUSCH is used for transmitting user data and control data from the mobile station apparatus to the base station apparatus. Note that data transmitted and received on the physical uplink shared channel PUSCH and the physical downlink shared channel PDSCH is subjected to HARQ (Hybrid Automatic Repeat reQuest) processing in which data initially transmitted and data re-transmitted are combined at the time of re-transmission to improve the capability of correcting errors in the re-transmitted data. The physical uplink control channel PUCCH is used to notify the base station apparatus of control information, such as a response (Ack (Acknowledgement)/Nack (Negative Acknowledgement)) to downlink data transmitted from the base station apparatus and downlink radio channel quality information.

The random access channel RACH is mainly used for transmitting a random access preamble from the mobile station apparatus to the base station apparatus in order to acquire transmission timing information. The random access preamble is transmitted during a random access procedure. The demodulation reference signal of the uplink reference signal is used by the base station apparatus to demodulate the physical uplink shared channel PUSCH. The demodulation reference signal is inserted at the fourth and eleventh symbol positions of the physical uplink shared channel PUSCH. The sounding reference signal of the uplink reference signal is used by the base station apparatus to measure an uplink radio channel quality. The sounding reference signal is inserted at the fourteenth symbol position of the physical uplink shared channel PUSCH. Note that a radio resource used for transmitting the sounding reference signal is separately allocated to each mobile station apparatus by the base station apparatus.

The random access procedure takes two forms: a procedure of contention based random access and a procedure of non-contention based random access (NPL 1).

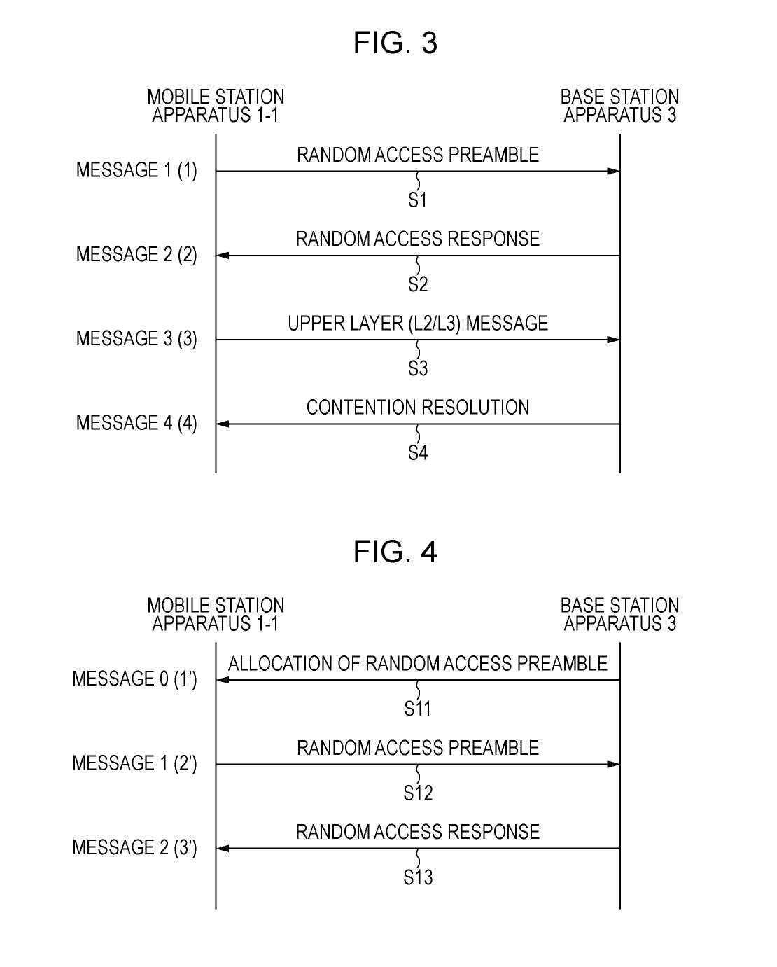

FIG. 3 is a diagram illustrating the contention based random access procedure. Contention based random access is a random access procedure involving possible contention among mobile station apparatuses. Contention based random access is carried out to make a scheduling request or the like when initial access is attempted in a state where no connection (communication) to the base station apparatus has been established and when uplink data transmission occurs in the mobile station apparatus in a state where connection to the base station apparatus is maintained but uplink synchronization is lost.

FIG. 4 is a diagram illustrating the non-contention based random access procedure. Non-contention based random access is a random access procedure which does not involve any contention among mobile station apparatuses. The mobile station apparatus is instructed to start the non-contention based random access procedure by the base station apparatus in special cases, such as in a case where handover is carried out to quickly establish uplink synchronization between the mobile station apparatus and the base station apparatus when uplink synchronization is lost and in a case where the transmission timing of the mobile station apparatus is invalid, in a state where connection between the base station apparatus and the mobile station apparatus is maintained (NPL 1). Non-contention based random access is specified by a message of the RRC (Radio Resource Control: Layer 3) layer and control data on the physical downlink control channel PDCCH.

The contention based random access procedure will be briefly described using FIG. 3. First, a mobile station apparatus 1-1 transmits a random access preamble to a base station apparatus 3 (message 1(1), step S1). Then, the base station apparatus 3 having received the random access preamble transmits a response (random access response) to the random access preamble to the mobile station apparatus 1-1 (message 2(2), step S2). The mobile station apparatus 1-1 transmits an upper layer (Layer 2/Layer 3) message on the basis of scheduling information contained in the random access response (message 3(3), step S3). The base station apparatus 3 transmits a contention check message to the mobile station apparatus 1-1 from which the base station apparatus 3 has successfully received the upper layer message (3) (message 4(4), step S4). Note that contention based random access is also referred to as random preamble transmission.

The non-contention based random access procedure will be briefly described using FIG. 4. First, the base station apparatus 3 notifies the mobile station apparatus 1-1 of a preamble number (or sequence number) and a random access channel number to be used (message 0(1′), step S11). The mobile station apparatus 1-1 transmits a random access preamble of the specified preamble number on the specified random access channel RACH (message 1(2′), step S12). Then, the base station apparatus 3 having received the random access preamble transmits a response (random access response) to the random access preamble to the mobile station apparatus 1-1 (message 2(3′), step S13). In a case where the value of the notified preamble number is 0, the mobile station apparatus 1-1 carries out contention based random access. Note that non-contention based random access is also referred to as dedicated preamble transmission.

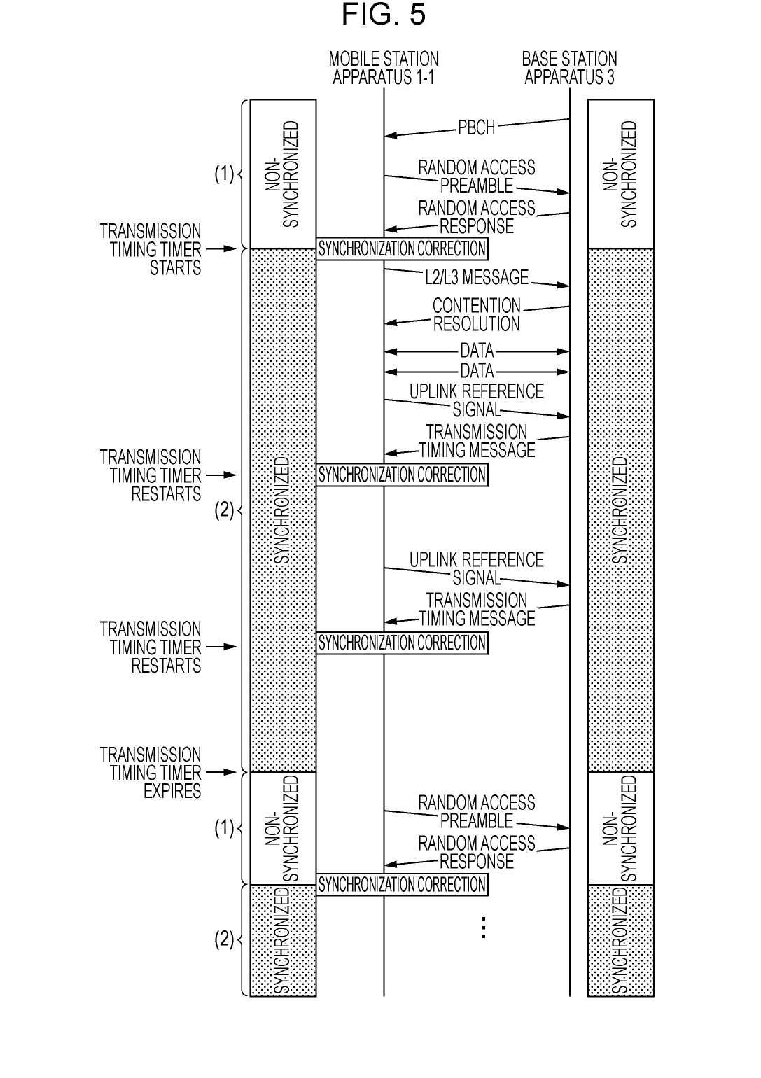

A procedure in which the mobile station apparatus 1-1 establishes a connection to the base station apparatus 3 will be described using FIGS. 3 and 5. First, the mobile station apparatus 1-1 acquires system information about the base station apparatus 3 from the physical broadcast channel PBCH or the like. The mobile station apparatus 1-1 executes a random access procedure on the basis of random access related information contained in the system information so as to establish a connection to the base station apparatus 3. Specifically, the mobile station apparatus 1-1 generates a random access preamble on the basis of the random access related information or the like contained in the system information. The mobile station apparatus 1-1 then transmits the random access preamble on the random access channel RACH (message 1(1)).

Upon detecting the random access preamble transmitted from the mobile station apparatus 1-1, the base station apparatus 3 calculates an amount of difference in transmission timing between the mobile station apparatus 1-1 and the base station apparatus 3 by using the random access preamble. The base station apparatus 3 then performs scheduling for transmitting a Layer 2 (L2)/Layer 3 (L3) message (specifies the position of an uplink radio resource (the position of the physical uplink shared channel PUSCH), a transmission format (message size), and so forth). The base station apparatus 3 then assigns Temporary C-RNTI (Cell-Radio Network Temporary Identity: mobile station apparatus identification information); and maps, onto the physical downlink control channel PDCCH, RA-RNTI (Random Access-Radio Network Temporary Identify: random access response identification information) which represents a response (random access response) addressed to the mobile station apparatus 1-1 that has transmitted the random access preamble on the random access channel RACH. The base station apparatus 3 then transmits, on the physical downlink shared channel PDSCH, a random access response message which contains transmission timing information, scheduling information, the Temporary C-RNTI, and information about the received random access preamble (message 2(2)).

Upon detecting the RA-RNTI on the physical downlink control channel PDCCH, the mobile station apparatus 1-1 checks the content of the random access response message mapped on the physical downlink shared channel PDSCH. If the random access response message contains information about the transmitted random access preamble, the mobile station apparatus 1-1 adjusts the uplink transmission timing on the basis of the transmission timing information contained in the random access response message; and transmits, using the scheduled radio resource and transmission format, an L2/L3 message which contains information identifying the mobile station apparatus 1-1, such as C-RNTI (or Temporary C-RNTI) or IMSI (International Mobile Subscriber Identity) (message 3(3)). Upon adjusting the transmission timing, the mobile station apparatus 1-1 starts a transmission timing timer, for which the adjusted transmission timing is valid. Note that the adjusted transmission timing becomes invalid upon expiration of this transmission timing timer. While the transmission timing is valid, the mobile station apparatus 1-1 is permitted to transmit data to the base station apparatus 3. When the transmission timing is invalid, the mobile station apparatus 1-1 is permitted to transmit only a random access preamble. A period for which the transmission timing is valid is also referred to as an uplink synchronized state, whereas a period for which the transmission timing is invalid is also referred to as an uplink non-synchronized state.

Upon receiving the L2/L3 message from the mobile station apparatus 1-1, the base station apparatus 3 transmits, using the C-RNTI (or Temporary C-RNTI) or IMSI contained in the received L2/L3 message, a contention check (contention resolution) message to the mobile station apparatus 1-1 in order to determine whether or not contention has occurred among the mobile station apparatuses 1-1 to 1-3 (message 4(4)).

The mobile station apparatus 1-1 re-transmits the random access preamble (message 1(1)) if the mobile station apparatus 1-1 does not detect any random access response message containing the preamble number corresponding to the transmitted random access preamble within a certain period, has failed to transmit the message 3, or does not detect identification information of the mobile station apparatus 1-1 in the contention check message within a certain period. If the number of times the random access preamble has been transmitted exceeds the maximum number of times the random access preamble is permitted to be transmitted, which is indicated by the system information, the mobile station apparatus 1-1 determines that random access has failed and disconnects communication to the base station apparatus 3. After the random access procedure is successfully completed, control data for establishing a connection is further exchanged between the base station apparatus 3 and the mobile station apparatus 1-1. At this time, the base station apparatus 3 notifies the mobile station apparatus 1-1 of allocation information regarding the uplink reference signal and the physical uplink control channel PUCCH which are allocated individually.

As illustrated in FIG. 5, after the random access procedure has been completed, the uplink transmission timing is updated in a manner as follows: the base station apparatus 3 measures the uplink reference signal (the sounding reference signal or the demodulation reference signal) transmitted from the mobile station apparatus 1-1 to calculate transmission timing information, and notifies the mobile station apparatus 1-1 of a transmission timing message which contains the calculated transmission timing information. After adjusting the uplink transmission timing on the basis of the transmission timing information that the mobile station apparatus 1-1 is notified of by the base station apparatus 3, the mobile station apparatus 1-1 restarts a corresponding transmission timing timer. Note that the base station apparatus 3 also has the same transmission timing timer as the mobile station apparatus 1-1. The base station apparatus 3 starts or restarts the transmission timing timer upon transmitting the transmission timing message. In this way, the base station apparatus 3 and the mobile station apparatus 1-1 manage the uplink synchronized state. The transmission timing becomes invalid upon expiration of the transmission timing timer, and uplink transmission is stopped except for transmission of a random access preamble.

In 3GPP, discussions over Advanced-EUTRA which is further advancements for EUTRA have begun. Advanced-EUTRA assumes communications at a downlink peak transmission rate of 1 Gbps or higher and at an uplink peak transmission rate of 500 Mbps or higher by using a band having a bandwidth of up to 100 MHz in each of the uplink and the downlink.

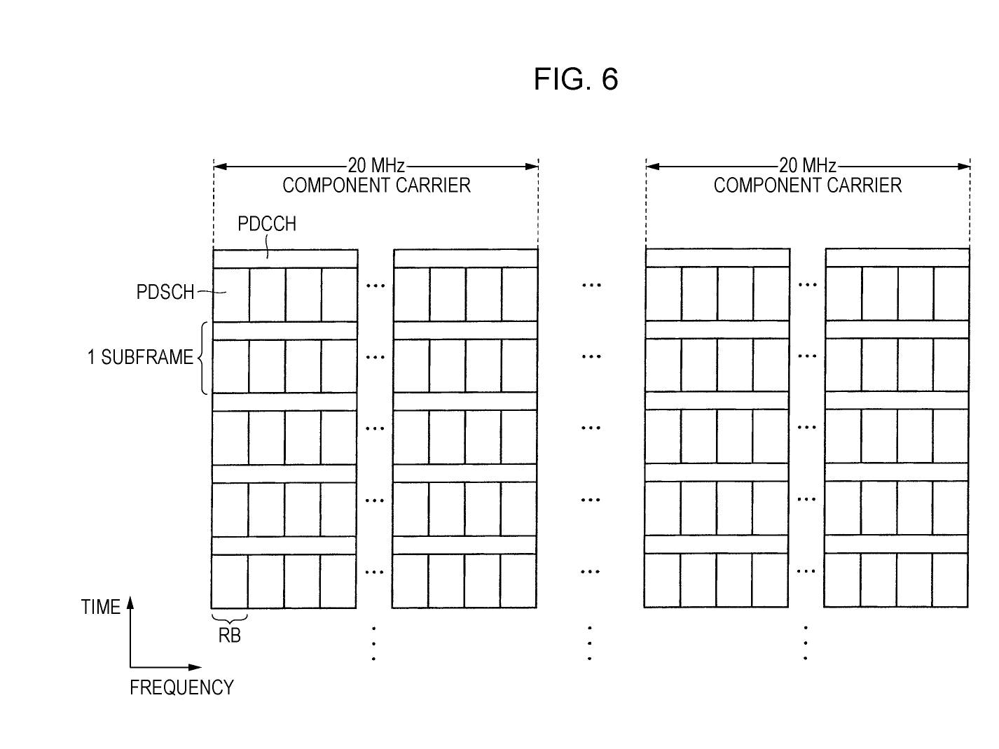

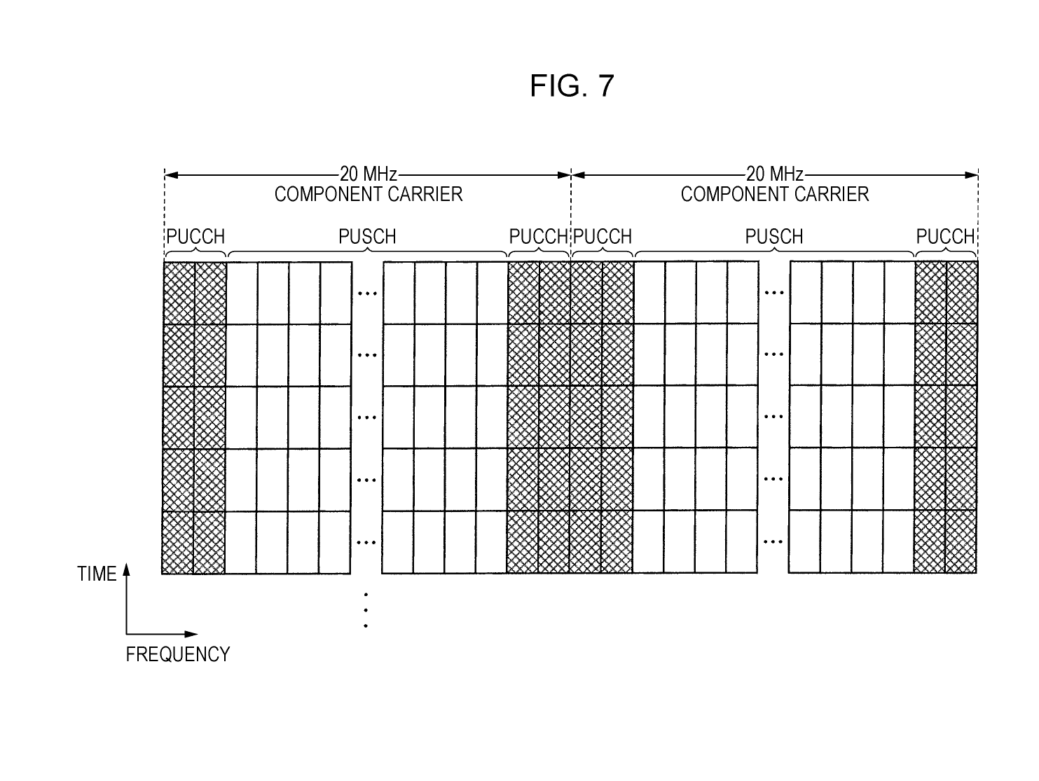

FIG. 6 is an explanatory diagram regarding downlink component carriers in Advanced-EUTRA. FIG. 7 is an explanatory diagram regarding uplink component carriers in Advanced-EUTRA.

It is conceived that a band of up to 100 MHz is realized in Advanced-EUTRA by aggregating a plurality of EUTRA bands, each of which has a bandwidth of 20 MHz or less, in order to support EUTRA mobile station apparatuses. In Advanced-EUTRA, each EUTRA band of 20 MHz or less is called a component carrier (CC) (NPL 2). One downlink component carrier and one uplink component carrier constitute one cell. Note that one downlink component carrier alone can constitute one cell.

Specifically, the base station apparatus assigns a plurality of cells suitable for the communication capacity and communication condition of the mobile station apparatus and performs communication with the mobile station apparatus via the plurality of assigned cells. Note that among the plurality of cells assigned to the mobile station apparatus, one cell is set as a primary cell and the rest of the cells are set as secondary cells. Special functions, such as allocation of the physical uplink control channel PUCCH, permission of access to the random access channel RACH, and the like, are set for the primary cell.

Also, in order to reduce the power consumption of the mobile station apparatus, the mobile station apparatus is configured not to perform a downlink reception process for the secondary cells immediately after the allocation (or not to act in accordance with the radio resource allocation information given on the physical downlink control channel); and after an instruction to activate is given by the base station apparatus, to start the downlink reception process for the secondary cell for which the instruction to activate is given (or to act in accordance with the radio resource allocation information given on the physical downlink control channel). Also, after the mobile station apparatus is instructed to deactivate an activated secondary cell by the base station apparatus, the mobile station apparatus stops the downlink reception process for the secondary cell for which the instruction to deactivate is given (or not to act in accordance with the radio resource allocation information given on the physical downlink control channel). Note that secondary cells for which an instruction to activate has been given by the base station apparatus and in which the downlink reception process is being performed are referred to as activated cells, whereas secondary cells that have just been assigned to the mobile station apparatus by the base station apparatus and secondary cells for which an instruction to deactivate is given and in which the downlink reception process is stopped are referred to as deactivated cells. The primary cell is always an activated cell.

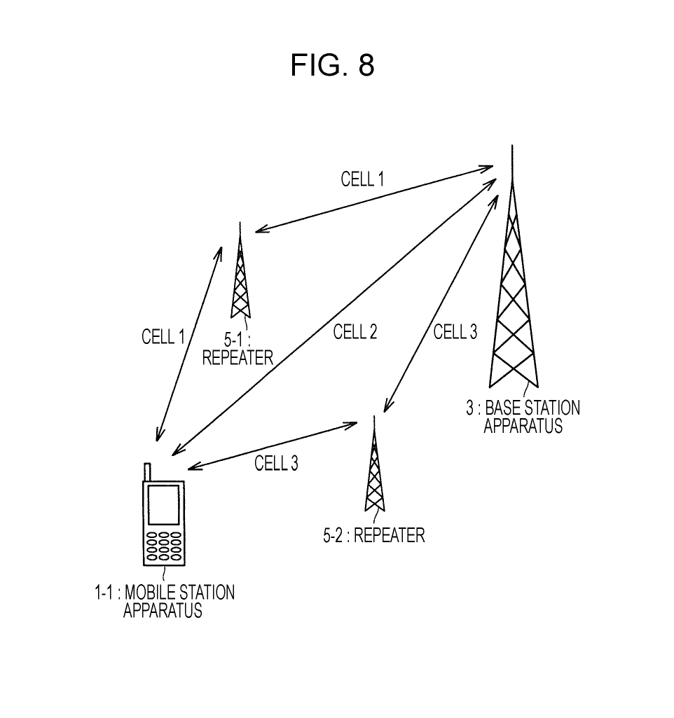

In a case where the mobile station apparatus performs communication with the base station apparatus by using a plurality of cells, the mobile station apparatus sometimes accesses the base station apparatus via a repeater or the like as illustrated in FIG. 8. In such a case, the reception timing at which the mobile station apparatus receives data on the downlink component carrier and/or the transmission timing at which the mobile station apparatus performs transmission to the base station apparatus on the uplink component carrier differs from one cell to another. In particular, in a case where the transmission timings at which the mobile station apparatus performs transmission to the base station apparatus on individual uplink component carriers differ from one another, the mobile station apparatus is required to adjust the transmission timings for the individual uplink component carriers of individual cells before transmitting data to the base station apparatus.

[Configuration]

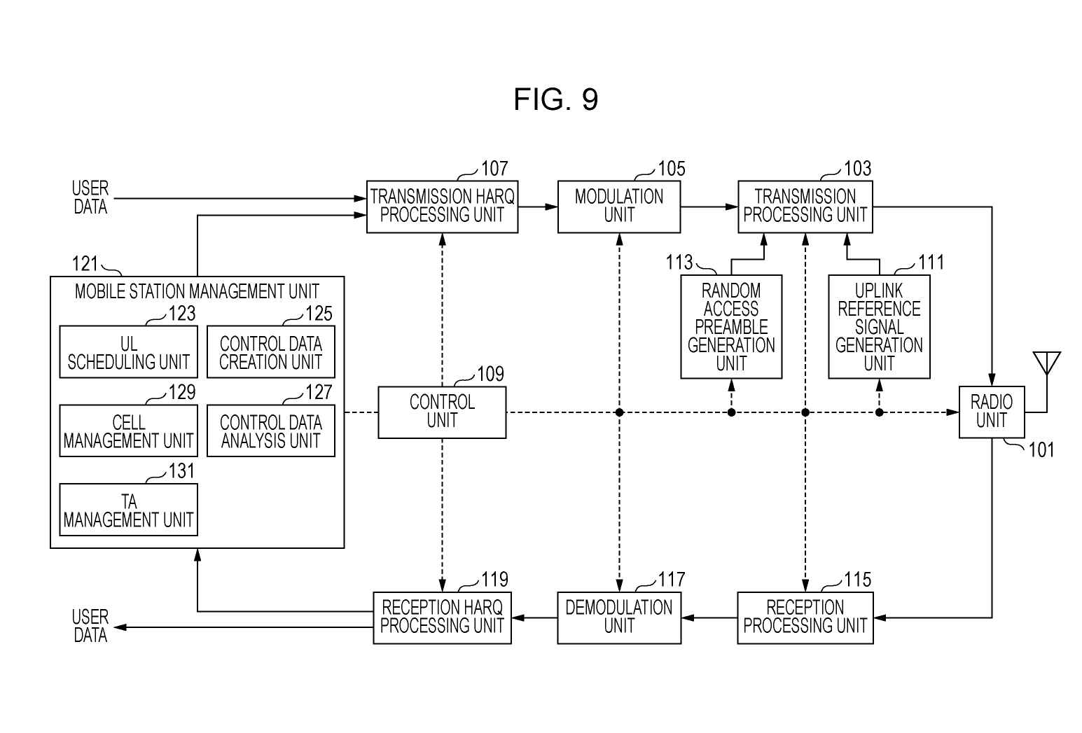

FIG. 9 is a diagram illustrating the configuration of a mobile station apparatus according to an embodiment of the present invention. Mobile station apparatuses 1-1 to 1-3 each include a radio unit 101, a transmission processing unit 103, a modulation unit 105, a transmission HARQ processing unit 107, a control unit 109, an uplink reference signal generation unit 111, a random access preamble generation unit 113, a reception processing unit 115, a demodulation unit 117, a reception HARQ processing unit 119, and a mobile station management unit 121. The mobile station management unit 121 includes a UL scheduling unit 123, a control data creation unit 125, a control data analysis unit 127, a cell management unit 129, and a TA management unit 131.

User data and control data are input to the transmission HARQ processing unit 107. In response to an instruction from the control unit 109, the transmission HARQ processing unit 107 encodes the input data and performs puncture processing on the encoded data. The transmission HARQ processing unit 107 then outputs the punctured data to the modulation unit 105 and stores the encoded data therein. Also, when the transmission HARQ processing unit 107 is instructed by the control unit 109 to re-transmit data, the transmission HARQ processing unit 107 performs puncture processing of a kind different from the one performed last time on the stored encoded data, and outputs the punctured data to the modulation unit 105. The transmission HARQ processing unit 107 deletes the data stored therein, in response to an instruction from the control unit 109.

The modulation unit 105 modulates the data input from the transmission HARQ processing unit 107, and outputs the resulting data to the transmission processing unit 103. The transmission processing unit 103 maps pieces of data (or signals) input from the modulation unit 105, the uplink reference signal generation unit 111, and the random access preamble generation unit 113 onto corresponding channels of the uplink component carrier of each cell in response to an instruction from the control unit 109; and performs OFDM signal processing, such as serial/parallel conversion, DFT-IFFT (Inverse Fast Fourier Transform), and CP insertion, on the mapped pieces of data to generate an OFDM signal. The transmission processing unit 103 also adjusts the transmission timing of the signal output on the uplink component carrier of each cell, on the basis of the transmission timing information and transmission timing group information regarding a group for which the transmission timing is adjusted, the transmission timing information and the transmission timing group information being fed from the control unit 109. After adjusting the transmission timing, the transmission processing unit 103 outputs the OFDM signal to the radio unit 101.

In response to an instruction from the control unit 109, the uplink reference signal generation unit 111 generates uplink reference signals on the basis of uplink reference signal generation information acquired from the mobile station management unit 121, and outputs the generated uplink reference signals to the transmission processing unit

103. In response to an instruction from the control unit 109, the random access preamble generation unit 113 generates a random access preamble on the basis of random access related information acquired from the mobile station management unit 121, and outputs the generated random access preamble to the transmission processing unit 103.

In response to an instruction from the control unit 109, the radio unit 101 up-converts the signal input from the transmission processing unit 103 into a signal of a radio frequency, and transmits the signal from a transmit antenna. Also, the radio unit 101 down-converts a radio signal received from an antenna, and outputs the resulting signal to the reception processing unit 115. The reception processing unit 115 performs FFT (Fast Fourier Transform) processing on the signal input from the radio unit 101, and outputs the resulting signal to the demodulation unit 117. The demodulation unit 117 performs demodulation processing on the input data, and outputs the demodulated data to the reception HARQ processing unit 119.

The reception HARQ processing unit 119 performs decoding processing on the input data. If the decoding processing is successful, the reception HARQ processing unit 119 outputs control data to the mobile station management unit 121 and outputs user data to an upper layer. If the decoding processing performed on the input data is unsuccessful, the reception HARQ processing unit 119 stores the data for which the decoding processing ended unsuccessful therein. When receiving re-transmitted data, the reception HARQ processing unit 119 combines the data stored therein and the re-transmitted data with each other and performs decoding processing. Also, the reception HARQ processing unit 119 notifies the mobile station management unit 121 that whether or not decoding processing performed on the input data is successful. The reception HARQ processing unit 119 deletes the data stored therein, in response to an instruction from the control unit 109.

In accordance with an instruction from the mobile station management unit 121, the control unit 109 controls the radio unit 101, the transmission processing unit 103, the modulation unit 105, the transmission HARQ processing unit 107, the uplink reference signal generation unit 111, the random access preamble generation unit 113, the reception processing unit 115, the demodulation unit 117, and the reception HARQ processing unit 119.

The mobile station management unit 121 includes the UL scheduling unit 123, the control data creation unit 125, the control data analysis unit 127, the cell management unit 129, and the TA management unit 131. The control data creation unit 125 creates an ACK/NACK message for received data, on the basis of a data decoding result supplied from the reception HARQ processing unit 119. The control data creation unit 125 also creates control data, such as a message indicating a downlink radio quality, and outputs the created control data to the transmission HARQ processing unit 107. The control data analysis unit 127 analyzes control data input from the reception HARQ processing unit 119. The control data analysis unit 127 outputs, to the cell management unit 129, the cell system information, cell allocation information, a random access response message, and uplink reference signal generation information which are received from the base station apparatus 3. The control data analysis unit 127 also outputs the transmission timing message, information about a cell in which the transmission timing message is acquired, and the transmission timing timer information to the TA management unit 131.

The UL scheduling unit 123 controls, via the control unit 109, the transmission processing unit 103, the modulation unit 105, and the transmission HARQ processing unit 107 in accordance with uplink data scheduling information or a response (ACK/NACK) to transmitted uplink data which is received from the base station apparatus 3. Also, the UL scheduling unit 123 instructs the cell management unit 129 to start random access, in accordance with control information supplied from an upper layer.

The cell management unit 129 manages cells assigned by the base station apparatus 3. The cell management unit 129 manages the physical channel configuration, transmission power information, and random access related information that are received for each cell from the base station apparatus 3; and the cell system information regarding each cell, such as uplink reference signal generation information, and radio resources individually allocated to the mobile station apparatus 1-1, such as radio resources for the uplink reference signal (sounding reference signal) and radio resources for the physical uplink control channel PUCCH. The cell management unit 129 notifies, via the control unit 109, the random access preamble generation unit 113 of the random access related information and the uplink reference signal generation unit 111 of the uplink reference signal generation information. The cell management unit 129 notifies the TA management unit 131 of group information regarding cells having an identical transmission timing. When initiating communication or making an uplink data scheduling request, the cell management unit 129 instructs, via the control unit 109, the random access preamble generation unit 113 to transmit a random access preamble to the base station apparatus 3.

Upon being notified of expiration of a transmission timing timer by the TA management unit 131, the cell management unit 129 instructs, via the control unit 109, the transmission HARQ processing unit 107 to stop HARQ processing for a cell for which the transmission timing has expired and to delete data stored therein in association with the cell for which the transmission timing has expired, and the uplink reference signal generation unit 111 to stop generating the uplink reference signal for the cell for which the transmission timing has expired. Also, the cell management unit 129 releases radio resources for the physical uplink control channel PUCCH and the uplink reference signal (sounding reference signal) that are allocated by the base station apparatus 3 to the cell for which the transmission timing has expired.

The TA management unit 131 manages transmission timings and transmission timing timers for individual cells or for individual transmission timing groups. The TA management unit 131 also manages group information regarding cells having an identical transmission timing. When acquiring a transmission timing message, the TA management unit 131 notifies, via the control unit 109, the transmission processing unit 103 of transmission timing information and transmission timing group information regarding a group to which transmission timing contained in the transmission timing message is to be applied, and starts or restarts a transmission timing timer for the transmission timing group to which the transmission timing is to be applied. Then, the TA management unit 131 notifies the cell management unit 129 that the transmission timing timer has started or restarted for the corresponding cell. Also, when the transmission timing timer has expired for a cell, the TA management unit 131 notifies the cell management unit 129 that the transmission timing timer for the cell has expired.

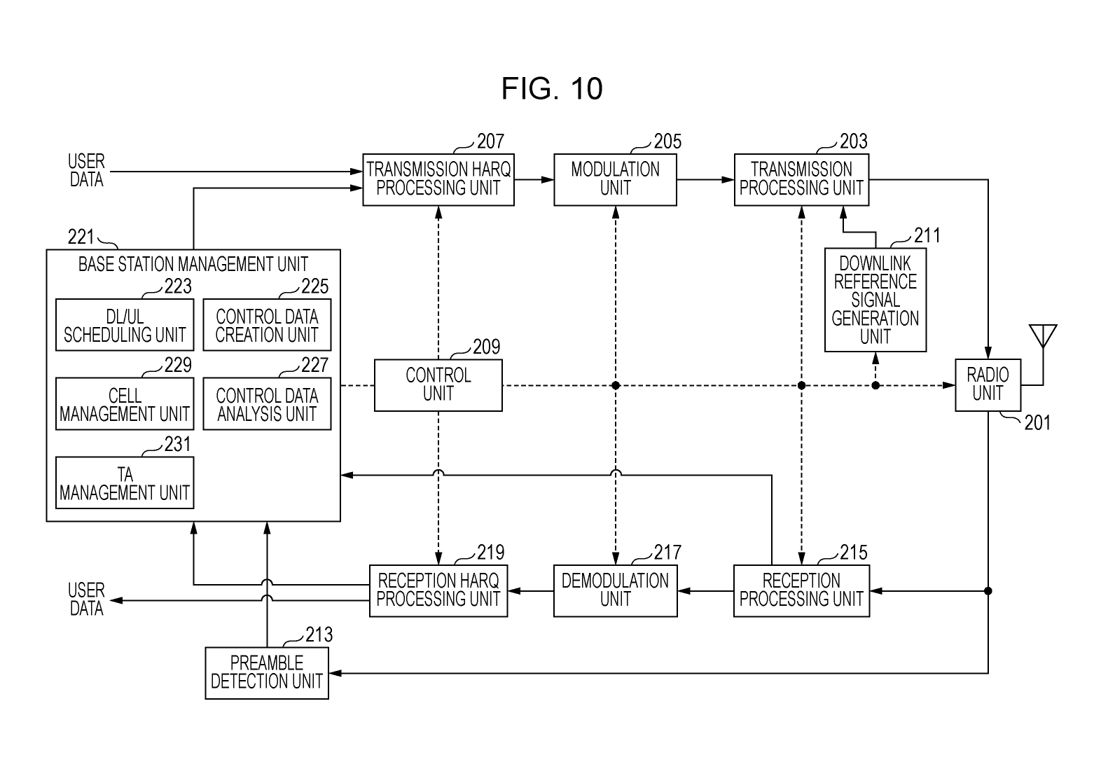

FIG. 10 is a diagram illustrating the configuration of the base station apparatus 3 according to the embodiment of the present invention. The base station apparatus 3 includes a radio unit 201, a transmission processing unit 203, a modulation unit 205, a transmission HARQ processing unit 207, a control unit 209, a downlink reference signal generation unit 211, a preamble detection unit 213, a reception processing unit 215, a demodulation unit 217, a reception HARQ processing unit 219, and a base station management unit 221. The base station management unit 221 includes a DL/UL scheduling unit 223, a control data creation unit 225, a control data analysis unit 227, a cell management unit 229, and a TA management unit 231.

User data and control data are input to the transmission HARQ processing unit 207. In response to an instruction from the control unit 209, the transmission HARQ processing unit 207 encodes the input data and performs puncture processing on the encoded data. The transmission HARQ processing unit 207 then outputs the punctured data to the modulation unit 205 and stores the encoded data therein. Also, when the transmission HARQ processing unit 207 is instructed by the control unit 209 to re-transmit data, the transmission HARQ processing unit 207 performs puncture processing of a kind different from the one performed last time on the stored encoded data and outputs the punctured data to the modulation unit 205. The transmission HARQ processing unit 207 deletes the data stored therein, in response to an instruction from the control unit 209.

The modulation unit 205 modulates the data input from the transmission HARQ processing unit 207, and outputs the resulting data to the transmission processing unit 203. The transmission processing unit 203 maps pieces of data (or signals) input from the modulation unit 205 and the downlink reference signal generation unit 211 to corresponding channels, such as the physical downlink control channel PDSCH, the downlink synchronization channel DSCH, the physical broadcast channel PBCH, and the physical downlink shared channel PDSCH, of the downlink component carrier of each cell in response to an instruction from the control unit 209; and performs OFDM signal processing, such as serial/parallel conversion, IFFT (Inverse Fast Fourier Transform), and CP insertion, on the mapped pieces of data to generate an OFDM signal. The transmission processing unit 203 then outputs the generated OFDM signal to the radio unit 201.

In response to an instruction from the control unit 209, the radio unit 201 up-converts the signal input from the transmission processing unit 203 into a signal of a radio frequency, and transmits the signal from a transmit antenna to the mobile station apparatuses 1-1 to 1-3. The radio unit 201 also receives a radio signal from the mobile station apparatus 1-1 with an antenna, down-converts the received signal into a baseband signal, and outputs the resulting received signal to the reception processing unit 215 or the preamble detection unit 213. The reception processing unit 215 performs FFT (Fast Fourier Transform) processing on the signal input from the radio unit 201, and outputs the resulting signal to the demodulation unit 217. The reception processing unit 215 also measures a radio channel quality and an amount of difference in transmission timing from the uplink reference signal (sounding reference signal), and supplies the measurement result to the base station management unit 221. Note that the use of a single-carrier scheme, such as DFT-spread OFDM, as an uplink communication scheme is assumed but a multi-carrier scheme, such as OFDM, may be used. The demodulation unit 217 performs demodulation processing on the input data, and outputs the demodulated data to the reception HARQ processing unit 219.

The reception HARQ processing unit 219 performs decoding processing on the input data. If the decoding processing is successful, the reception HARQ processing unit 219 outputs control data to the base station management unit 221 and outputs user data to an upper layer. If the decoding processing performed on the input data is unsuccessful, the reception HARQ processing unit 219 stores the data for which the decoding processing ended unsuccessful therein. When receiving re-transmitted data, the reception HARQ processing unit 219 combines the data stored therein and the re-transmitted data with each other and performs decoding processing. Also, the reception HARQ processing unit 219 notifies the base station management unit 221 that whether or not decoding processing performed on the input data is successful. The reception HARQ processing unit 219 deletes the data stored therein, in response to an instruction from the control unit 209.

The preamble detection unit 213 performs correlation processing on the signal input from the radio unit 201 to detect a random access preamble. Upon detecting a random access preamble, the preamble detection unit 213 calculates an amount of difference in transmission timing on the basis of the detected random access preamble. The preamble detection unit 213 notifies the base station management unit 221 of the cell for which the random access preamble has been detected, information about the detected preamble, and the amount of difference in transmission timing. In accordance with an instruction from the base station management unit 221, the control unit 209 controls the radio unit 201, the transmission processing unit 203, the modulation unit 205, the transmission HARQ processing unit 207, the downlink reference signal generation unit 211, the reception processing unit 215, the demodulation unit 217, and the reception HARQ processing unit 219.

The base station management unit 221 includes the DL/UL scheduling unit 223 that performs downlink and uplink scheduling, the control data creation unit 225, the control data analysis unit 227, the cell management unit 229, and the TA management unit 231. The DL/UL scheduling unit 223 performs scheduling for mapping user data and control data to corresponding downlink channels, in accordance with the downlink radio channel quality information which the base station apparatus 3 is notified of by the mobile station apparatus 1-1 and user data information notified by an upper layer or control data created by the control data creation unit 225. The DL/UL scheduling unit 223 then supplies the scheduling result to the control unit 209. The DL/UL scheduling unit 223 also performs scheduling for mapping user data to corresponding uplink channels, in accordance with the result regarding the uplink radio channel quality supplied from the reception processing unit 215 and a radio resource allocation request transmitted from the mobile station apparatus 1-1.

When being notified of detection of a random access preamble by the preamble detection unit 213, the DL/UL scheduling unit 223 allocates the physical uplink shared channel PUSCH and notifies the control data creation unit 225 of the allocated physical uplink shared channel PUSCH and a preamble number. When being notified by the TA management unit 231 of transmission timing information and transmission timing group information regarding a group to which the transmission timing is to be applied, the DL/UL scheduling unit 223 determines whether or not to notify the mobile station apparatus 1-1 of the transmission timing information in accordance with the uplink and downlink scheduling state of the mobile station apparatus 1-1. In a case where the DL/UL scheduling unit 223 notifies the mobile station apparatus 1-1 of the transmission timing information, the DL/UL scheduling unit 223 reports to the TA management unit 231 transmission of the transmission timing information, and notifies the control data creation unit 225 of the transmission timing information and the transmission timing group information regarding a group to which the transmission timing is to be applied.

The control data creation unit 225 creates control data to be mapped on the physical downlink control channel PDCCH and control data to be mapped on the physical downlink shared channel PDSCH. The control data creation unit 225 creates control data, such as a control message which contains scheduling information, and a response (ACK/NACK) to uplink data; a system information message which contains the physical channel configuration information, transmission power information for each channel, and random access related information; an initial setup message which contains setup information of a cell to be used (containing random access related information); a random access response message which contains a preamble number, transmission timing information, and scheduling information; a contention resolution message; and a transmission timing message which contains transmission timing information. The control data analysis unit 227 controls, via the control unit 209, the transmission HARQ processing unit 207 in accordance with a result of a response (ACK/NACK) to downlink data, the response being transmitted from the mobile station apparatus 1-1.

The cell management unit 229 manages individual cells and pieces of system information (the physical channel configuration information, transmission power information for each channel, random access related information, and cell relationship information in terms of transmission timing) for the individual cells. The cell management unit 229 also assigns one or more cells to each of the mobile station apparatuses 1-1 to 1-3. Moreover, the cell management unit 229 allocates a radio resource for the uplink reference signal (sounding reference signal) and a radio resource for the physical uplink control channel PUCCH. The cell management unit 229 then supplies the control data creation unit 225 with the cell allocation information, the cell system information, the radio resource allocation information, and so forth to make a notification of the information about the assigned cells.

When being notified of expiration of a transmission timing timer by the TA management unit 231, the cell management unit 229 instructs, via the control unit 209, the transmission HARQ processing unit 207 to stop HARQ processing for a cell for which the transmission timing has expired and to delete data stored therein in association with the cell for which the transmission timing has expired, and releases the radio resource for the uplink reference signal (sounding reference signal) and the radio resource for the physical uplink control channel PUCCH that have been allocated to the mobile station apparatus 1-1.

The TA management unit 231 manages transmission timings and transmission timing timers for individual cells assigned to the mobile station apparatuses 1-1 to 1-3. The TA management unit 231 also manages cell relationship information regarding cells having an identical transmission timing. Upon acquiring an amount of difference in transmission timing from the preamble detection unit 213 or the reception processing unit 215, the TA management unit 231 creates transmission timing information and transmission timing group information regarding a group to which the transmission timing is to be applied, and notifies the DL/UL scheduling unit 223 of the created transmission timing information and the transmission timing group information regarding a group to which the transmission timing is to be applied. Upon being notified by the DL/UL scheduling unit 223 that the transmission timing information has been transmitted, the TA management unit 231 starts or restarts the corresponding transmission timing timer. Also, when a transmission timing timer has expired for a cell, the TA management unit 231 notifies the cell management unit 229 that the transmission timing timer for the cell has expired.

[Description of Operation]

The wireless communication system described in FIGS. 6 and 7 is assumed in which a base station apparatus assigns a plurality of cells to a mobile station apparatus and the mobile station apparatus performs communication with the base station apparatus via the plurality of assigned cells. Also, the wireless communication system described in FIG. 8 is assumed in which communication is performed via a plurality of cells in which transmission timings from the mobile station apparatus differ from one another.

In Advanced-EUTRA, a base station apparatus assigns one or more cells of different frequencies suitable for the communication capacity and communication condition of a mobile station apparatus from among a plurality of cells. The mobile station apparatus transmits and receives data to and from the base station apparatus via the assigned cells. In a case where a mobile station apparatus performs communication with a base station apparatus by using a plurality of cells, the mobile station apparatus sometimes accesses the base station apparatus via a repeater or the like as illustrated in FIG. 8. In such a case, the reception timing at which the mobile station apparatus receives data on the downlink component carrier sometimes differs from one cell to another. Furthermore, the transmission timing at which transmission to the base station apparatus is performed sometimes differs from one uplink component carrier of one cell to another uplink component carrier of another cell. For this reason, in a case where the transmission timing at which transmission to the base station apparatus is performed differs from one uplink component carrier to another, the mobile station apparatus is required to adjust the transmission timing for the uplink component carrier of each cell.

For this reason, the base station apparatus needs to make notification of transmission timing information for the uplink component carrier of each cell. However, in a case where there are a plurality of uplink component carriers having an identical transmission timing, making notification of transmission timing information for all the uplink component carriers indicates that the same transmission timing information is transmitted multiple times, resulting in a low radio resource utilization efficiency.

The base station apparatus groups cells into groups (hereinafter, grouped cells are referred to as a “transmission timing group”), in each of which cells have an identical transmission timing for transmission from the mobile station apparatus. The base station apparatus then sets one of the cells as a primary cell and sets the rest of the cells as secondary cells. The base station apparatus notifies the mobile station apparatus of transmission timing information and transmission timing group information regarding a group to which the transmission timing is to be applied. Upon acquiring the transmission timing information and the transmission timing group information regarding a group to which the transmission timing is to be applied, the mobile station apparatus applies, as the uplink transmission timing, the transmission timing information to a transmission timing group which is specified by the transmission timing group information and to which the transmission timing is to be applied, regardless of the cell in which the transmission timing information and the transmission timing group information regarding a group to which the transmission timing is to be applied have been acquired. This permits the base station apparatus to notify the mobile station apparatus of transmission timing information via any of the cells and requires the base station apparatus to notify the mobile station apparatus of just one piece of transmission timing information for one transmission timing group, omitting wasteful use of radio resources.

Note that the transmission timing groups are categorized into a first transmission timing group which is constituted by the primary cell and the secondary cells having the same uplink transmission timing as the primary cell, and a second transmission timing group which is constituted by the secondary cells having an identical uplink transmission timing that is different from the uplink transmission timing of the primary cell. The first transmission timing group includes at least the primary cell, whereas the second transmission timing group includes at least one secondary cell.

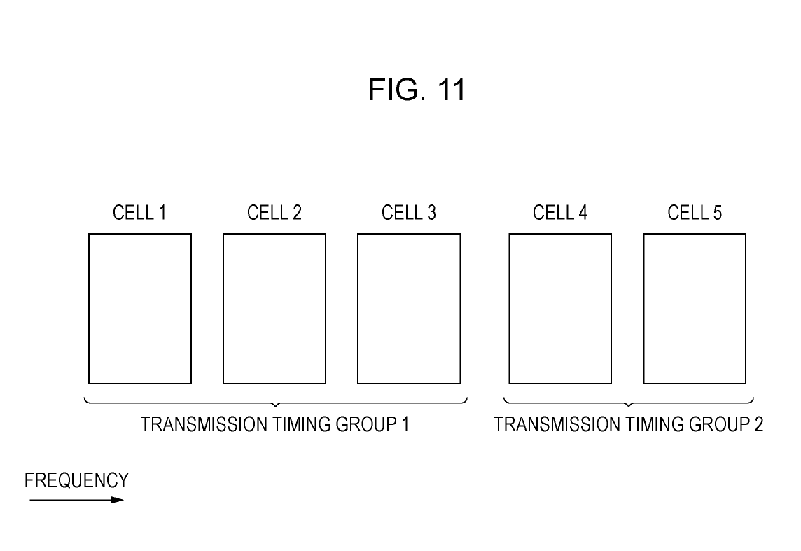

Operations of the mobile station apparatus 1-1 and the base station apparatus 3 will be described. By way of example, it is assumed that the base station apparatus 3 has cells 1 to 5, the cells 1 to 3 form a transmission timing group (transmission timing group 1) having an identical transmission timing, and the cells 4 and 5 form another transmission timing group (transmission timing group 2) having an identical transmission timing as illustrated in FIG. 11.

The mobile station apparatus 1-1 carries out cell search and finds one cell of the base station apparatus 3. Herein, suppose that the mobile station apparatus 1-1 finds the cell 1. The mobile station apparatus 1-1 receives a physical broadcast channel PBCH or the like of the cell 1 and acquires system information (such as the physical channel configuration, transmission power information, and random access related information of the cell). Then, by using the random access related information contained in the system information, the mobile station apparatus 1-1 transmits a random access preamble on the random access channel RACH of the cell 1 for initial access. The mobile station apparatus 1-1 acquires, from the base station apparatus 3, a random access response message which contains transmission timing information regarding the cell 1; adjusts the transmission timing for the uplink component carrier of the cell 1 on the basis of the transmission timing information contained in the random access response; and starts the corresponding transmission timing timer. The mobile station apparatus 1-1 transmits a message 3 to the base station apparatus 3 via the cell 1. Note that the mobile station apparatus 1-1 includes the content indicating initial access in this message 3 before transmitting the message 3. Upon receiving a contention resolution from the base station apparatus 3, the mobile station apparatus 1-1 ends the contention based random access procedure.

After the random access procedure has been completed, the base station apparatus 3 assigns cells to be used by the mobile station apparatus 1-1 and notifies the mobile station apparatus 1-1 of cell configuration information. Note that the cell configuration information includes cell information of the primary cell and information regarding transmission timing groups. Herein, the base station apparatus 3 assigns the cells 1 to 5 to the mobile station apparatus 1-1 and sets the cell 1 as the primary cell and the cells 2 to 5 as the secondary cells. The base station apparatus 3 also sets the cells 1 to 3 as a transmission timing group (transmission timing group 1) having an identical transmission timing and cells 4 and 5 as another transmission timing group (transmission timing group 2) having an identical transmission timing.

Then, the base station apparatus 3 notifies the mobile station apparatus 1-1 of setting information, such as system information regarding the cells assigned to the mobile station apparatus 1-1 and group information regarding transmission timing groups, allocation information regarding the physical uplink control channel PUCCH of the primary cell, uplink reference signal (sounding reference signal) generation information and radio resource allocation information for transmitting the uplink reference signal (sounding reference signal), and radio resource allocation information regarding the periodical physical uplink shared channel PUSCH. In this example, after the notification of the information, the base station apparatus 3 gives an instruction to activate to the mobile station apparatus 1-1 so as to instruct the mobile station apparatus 1-1 to start the downlink reception process in the cells 2 to 5.

After acquiring the system information regarding the assigned cells and the group information regarding the transmission timing groups, the mobile station apparatus 1-1 adjusts the uplink transmission timing of the cells 2 and 3 which belong to the same transmission timing group as the cell 1, on the basis of the group information of the transmission timing group and the acquired transmission timing information. Thereafter, the mobile station apparatus 1-1 and the base station apparatus 3 exchange data via downlink component carriers of the cells 1 to 5 and uplink component carriers of the cells 1 to 3.

In a case where the amount of data transmitted from the mobile station apparatus 1-1 has increased and there is a cell that is not being used by the mobile station apparatus 1-1, the base station apparatus 3 notifies, on the physical downlink control channel PDCCH, the mobile station apparatus 1-1 of random access instruction information for giving an instruction to perform non-contention based random access. Herein, the base station apparatus 3 notifies the mobile station apparatus 1-1 of random access instruction information for the cell 5. The random access instruction information contains a preamble number and a random access channel number. The mobile station apparatus 1-1 transmits a random access preamble on the random access channel RACH of the cell 5, by using the preamble and random access channel RACH specified by the base station apparatus 3.

Upon detecting the random access preamble, the base station apparatus 3 calculates an amount of difference in the transmission timing from the random access preamble, and notifies the mobile station apparatus 1-1 of a random access response, which contains the transmission timing information, on the downlink component carrier of the cell 5. Upon receiving the random access response, the mobile station apparatus 1-1 adjusts the uplink transmission timing of the cell 5 on the basis of the transmission timing information contained in the random access response and furthermore the uplink transmission timing of the cell 4 which belongs to the same transmission timing group on the basis of the transmission timing information. The mobile station apparatus 1-1 starts a corresponding transmission timing timer. Then, the mobile station apparatus 1-1 completes the non-contention based random access procedure. Thereafter, data is exchanged between the mobile station apparatus 1-1 and the base station apparatus 3 by additionally using the uplink component carriers of the cells 4 and 5.

The mobile station apparatus 1-1 has one transmission timing timer for each transmission timing group, and starts or restarts a corresponding transmission timing timer upon receiving transmission timing information. Similarly, the base station apparatus 3 also has one transmission timing timer for each transmission timing group, and starts or restarts a corresponding transmission timing timer upon transmitting transmission timing information. While the transmission timing timer is running, uplink synchronization is established (the transmission timing is valid). In this state, the mobile station apparatus 1-1 is permitted to perform uplink transmissions on uplink component carriers of the target transmission timing group. Note that one transmission timing timer may be prepared for each cell.

The base station apparatus 3 measures the uplink reference signals transmitted from the mobile station apparatus 1-1 in the individual cells so as to calculate an amount of difference in the transmission timing in the transmission timing group 1 or 2 of the mobile station apparatus 1-1. The base station apparatus 3 notifies the mobile station apparatus 1-1 of a transmission timing message, which contains transmission timing information and transmission timing group information regarding a group to which the transmission timing is to be applied, within a period over which the transmission timing of the transmission timing group is valid. Note that notification of the transmission timing message may be made in any of activated cells assigned by the base station apparatus 3 to the mobile station apparatus 1-1. The base station apparatus 3 selects a cell in which the transmission timing message is to be transmitted while taking into consideration an amount of transmission data in each cell or downlink radio channel characteristics of each cell before making notification of the transmission timing message.

For example, even if the transmission timing message indicates that transmission timing information is to be applied to the transmission timing group 1, the base station apparatus 3 can notify the mobile station apparatus 1-1 of the transmission timing message via any one of the cells 1 to 5. Upon receiving the transmission timing message in a given cell, the mobile station apparatus 1-1 uses the transmission timing information contained in the transmission timing message to adjust transmission timing of all cells of the transmission timing group specified by the transmission timing group information regarding a group to which the transmission timing contained in the transmission timing message is to be applied. For example, in a case where the mobile station apparatus 1-1 receives the transmission timing message in the cell 5 and the transmission timing group information regarding a group to which the transmission timing contained in the transmission timing message is to be applied specifies the transmission timing group 1, the mobile station apparatus 1-1 adjusts the transmission timing of the cells 1, 2, and 3 of the transmission timing group 1.

The state in which the downlink reception process is performed after an instruction to activate the cells 2 to 5, which are secondary cells, is given has been described above. However, if there is a cell for which an instruction to activate is not given (deactivated cell), the mobile station apparatus 1-1 need not adjust transmission timing of the deactivated cell. When an instruction to activate the deactivated cell is given, the mobile station apparatus 1-1 adjusts the transmission timing of the cell. Note that the transmission timing message may be transmitted alone or together with user data or another control message.

Also, the transmission timing may be calculated by the base station apparatus 3 from the uplink reference signal received in each cell or from the uplink reference signal received in a specific cell of each transmission timing group. Also, a transmission timing of one cell that is calculated at a certain time point may be used as the transmission timing to be notified or an average of transmission timings measured in individual cells of each transmission timing group may be used as the transmission timing.

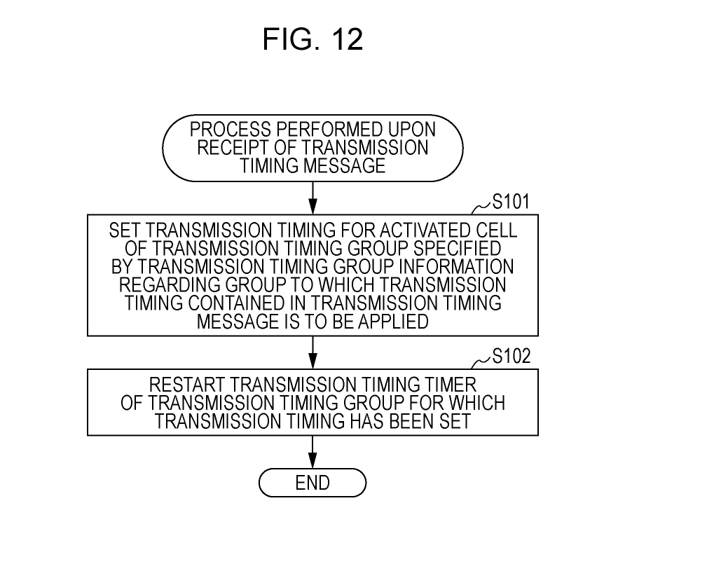

FIG. 12 illustrates a flowchart of a process performed by the mobile station apparatus 1-1 in response to reception of a transmission timing message. Upon receiving the transmission timing message via one certain cell, the mobile station apparatus 1-1 applies the transmission timing information contained in the transmission timing message, as an uplink transmission timing of an activated cell of a transmission timing group specified by the transmission timing group information regarding a group to which the transmission timing contained in the transmission timing message is to be applied (step S101). Then, the mobile station apparatus 1-1 restarts a transmission timing timer of the transmission timing group for which the transmission timing has been set (step S102).

Note that the transmission timing group information regarding a group to which the transmission timing contained in the transmission timing message is to be applied may be information regarding a cell to which the transmission timing is to be applied. In this case, if there are a plurality of cells to which the transmission timing is to be applied, the transmission timing group information is configured to indicate information regarding the plurality of cells. Also, in Advanced-EUTRA, special functions are exclusively given to the primary cell. Therefore, the transmission timing message may be transmitted only via the primary cell in the same way.

This configuration permits the base station apparatus 3 to notify the mobile station apparatus 1-1 of transmission timing information via any of the cells. This configuration also requires the base station apparatus 3 to notify the mobile station apparatus 1-1 of just one piece of transmission timing information for one transmission timing group, omitting wasteful use of radio resources.

While one embodiment of this invention has been described in detail above with reference to the drawings, specific configurations are not limited to the above-described ones and various design changes or the like can be made within a scope that does not deviate from the gist of this invention.

For the convenience of explanation, the mobile station apparatus 1-1 and the base station apparatus 3 according to the embodiment have been described by using functional block diagrams. A program for implementing the functions of the individual units of the mobile station apparatus 1-1 and the base station apparatus 3 or some of these functions may be recorded on a computer-readable recording medium, the program recorded on the recording medium may be loaded into a computer system so as to be executed, and thereby the mobile station apparatus and the base station apparatus may be controlled. The “computer system” used herein includes an OS (Operating System) and hardware, such as peripheral devices.

The “computer-readable recording medium” indicates a portable medium, such as a flexible disk, a magneto-optical disk, a ROM, or a CD-ROM; or a storage device, such as a hard disk drive built in the computer system. Furthermore, the “computer-readable recording medium” includes a medium which dynamically holds a program for a short time, such as a communication line used for transmitting a program via a network such as the Internet or a communication line such as a telephone line, and a medium which holds a program for a certain period, such as a volatile memory in the computer system serving as a server or a client in that case. The above-described program may be used for implementing some of the above-described functions, and may be a program with which the above-described functions can be implemented in combination with a program which has already been recorded in the computer system.

The individual functional blocks used in the above-described embodiment may be typically implemented as an LSI (Large Scale Integration), which is an integrated circuit. The individual functional blocks may be individually formed as chips, or some or all of them may be integrated into a chip. A method for integration may be a dedicated circuit or a general-purpose processor, as well as an LSI. In a case where the progress of semiconductor technologies produces an integration technology which replaces an LSI, an integrated circuit based on the technology can be used.

The embodiment of this invention has been described in detail above with reference to the drawings. Specific configurations are not limited to this embodiment, and design or the like within a scope that does not deviate from the gist of this invention is also included in the claims.

### REFERENCE SIGNS LIST

1 mobile station apparatus; 3 base station apparatus; 101, 201 radio unit; 103, 203 transmission processing unit; 105, 205 modulation unit; 107, 207 transmission HARQ processing unit; 109, 209 control unit; 111 uplink reference signal generation unit; 113 random access preamble generation unit; 115, 215 reception processing unit; 117, 217 demodulation unit; 119, 219 reception HARQ processing unit; 121 mobile station management unit; 123 UL scheduling unit; 125, 225 control data creation unit; 127, 227 control data analysis unit; 129, 229 cell management unit; 131, 231 TA management unit; 211 downlink reference signal generation unit; 213 preamble detection unit; 221 base station management unit; 223 DL/UL scheduling unit.

1-8. (canceled)

9. A base station apparatus that performs communication with a mobile station apparatus via a plurality of cells, the plurality of cells being grouped into a plurality of transmission timing groups each of which is a group of cells having an identical transmission timing for transmission from the mobile station apparatus, the base station apparatus comprising:
a base station management unit configured to create a transmission timing message containing transmission timing information and transmission timing group information regarding a transmission timing group to which the transmission timing information is to be applied; and
a radio unit configured to transmit the transmission timing message to the mobile station apparatus.

10. The base station apparatus according to claim 9, wherein the plurality of transmission timing groups include a transmission timing group that includes one primary cell which is always an activated cell.

11. A mobile station apparatus that performs communication with a base station apparatus via a plurality of cells, the plurality of cells being grouped into a plurality of transmission timing groups each of which is a group of cells having an identical transmission timing for transmission from the mobile station apparatus, the mobile station apparatus comprising:
a radio unit configured to receive a transmission timing message from the base station apparatus, the transmission timing message containing transmission timing information and transmission timing group information regarding a transmission timing group to which the transmission timing information is to be applied; and
a mobile station management unit configured to apply the transmission timing information as a transmission timing of a transmission timing group that is specified by the transmission timing group information.

12. The mobile station apparatus according to claim 11, wherein the mobile station management unit is configured to apply the transmission timing information to an activated cell of a transmission timing group that is specified by the transmission timing group information.

13. A wireless communication method employed in a mobile station apparatus that performs communication with a base station apparatus via a plurality of cells, the plurality of cells being grouped into a plurality of transmission timing groups each of which is a group of cells having an identical transmission timing for transmission from the mobile station apparatus, the wireless communication method comprising:
receiving a transmission timing message from the base station apparatus, transmission timing message containing transmission timing information and transmission timing group information regarding a transmission timing group to which the transmission timing information is to be applied; and
applying the transmission timing information as a transmission timing of a transmission timing group that is specified by the transmission timing group information.
